(19) United States
(12) Patent Application Publication
(10) Pub. No.: US 2013/0057708 A1
(43) Pub. Date: Mar. 7, 2013

(54) Real-time Wireless Image Logging Using a Standalone Digital Camera

(71) Applicant: Rick-William Govic, Melbourne (AU)

(72) Inventor: Rick-William Govic, Melbourne (AU)

(21) Appl. No.: 13/223,350

(22) Filed: Sep. 1, 2011

(51) Int. Cl. H04N 5/225

(52) U.S. Cl. 348/207.1; 348/E05.024

(57) ABSTRACT

Embodiments of the disclosed technology are directed towards a method for wirelessly logging an image taken by a standalone digital camera via a mobile device. The method involves connecting a digital camera to a mobile device with network connectivity, using a bridged connection or cable. Once the picture is taken and stored as an image on the digital camera, it is transferred to the mobile device. Upon receipt of the image by the mobile device, the image is forwarded to a network node via the mobile device's wireless network connection. The image may be stored on a network access drive and accessed remotely by a user. The logging of the image may be done automatically immediately after the photo is taken, or at a later time upon connection of the digital camera to the mobile device.

### FIELD OF THE DISCLOSED TECHNOLOGY

The disclosed technology relates generally to digital media and wireless networking. More specifically, the disclosed technology relates to a method for wirelessly logging images taken from a standalone digital camera.

### BACKGROUND OF THE DISCLOSED TECHNOLOGY

A standalone digital camera is a well-known and preferred form of photography. Unlike film cameras, digital cameras take digital images or videos and store them directly in internal memory or a memory card. Digital images are typically stored in a JPEG format (file extension “.jpg”). JPEG images are compatible with most personal computers and can be viewed, printed, and shared.

Typically, when a user desires to download images taken by a digital camera, the user plugs the camera into a personal computer, or removes the memory card and plugs it into the personal computer via a memory card reader. Then, if the user wishes to share the images, the user may choose to upload the images to the World Wide Web via the internet. This process can be rather tedious in that it requires access to a personal computer that is already connected to the internet by way of an internet service provider. Furthermore, it requires the user to manually perform two steps: 1) transfer images to stored memory of personal computer, and 2) upload images to a hosted web site.

A more recent innovation has been the introduction of Wi-Fi enabled digital memory cards. These memory cards are configured to automatically upload photos to a computer or web site, using a wireless access point or hotspot. This form of memory card alleviates the need for wires or cables. However, several shortcomings exist with respect to Wi-Fi enabled memory cards. Firstly, the memory card must initially be set up using a personal computer to specify which wireless network hotspots it utilizes, and any passwords that may be associated with such networks. This inevitably restricts many users to using their home wireless network, thus restricting use geographically. If a user is away from home, and he/she is within range of, for example, a free wireless hotspot provided by a coffee shop, the memory card must have been preconfigured to connect to that hotspot (passwords and all), or else the user is out of luck. Thus, if the user is traveling in an unfamiliar location, or a location away from any wireless hotspots, the user has no way of transferring photographs. Another shortcoming is that wireless memory cards are not compatible with all digital cameras.

Therefore, needed in the art is a method for real-time logging of images from a standalone digital camera from a much larger geographic perimeter than that provided by wireless hotspots.

### SUMMARY OF THE DISCLOSED TECHNOLOGY

The disclosed technology described herein addresses a need, unfulfilled in the prior art, for providing a method of logging images taken by a standalone digital camera, using a mobile device connected to wireless network.

Accordingly, it is an object of the disclosed technology to provide a method that alleviates the need for a user to plug a camera into a personal computer with internet access in order to share/upload images onto web page.

Accordingly, it is an object of the disclosed technology to provide a method that alleviates the need for a user to possess a special memory card, and be within range of a preconfigured Wi-Fi hotspot in order to log images.

It is a further object of the disclosed technology to provide a method of logging images to a network node in real-time, as soon as the image is taken.

Therefore, described herein is a method for wirelessly logging an image taken by a standalone digital camera via a mobile device.

In an embodiment of the disclosed technology, a method for wirelessly logging an image taken by a standalone digital camera via a mobile device is provided. The method begins by connecting the standalone digital camera to a mobile device, using a bridged connection between a video output port on the digital camera and a data input port on the mobile device. A “standalone digital camera” (herein “camera”), for the purposes of this specification, may include any digital single-lens reflex camera (“DSLR”), digital compact camera, bridge digital camera, or any other digital camera that is not wirelessly enabled. A “mobile device,” for the purposes of this specification, may be any compact electronic computing device that is capable of enabling wireless network access via a cellular network provided by a mobile network operator. This may include cellular phones, smart phones, personal digital assistants (“PDAs”), and tablet PCs.

Continuing with the method, the digital camera is configured to transfer a still image taken via the video output at the time of taking the picture. Once the picture is taken by the camera, the picture is stored as an image on a storage medium of the digital camera. At the same time, the image is also transferred to the mobile device. Once the image is received by the mobile device, it is forwarded to a network node via the wireless network.

In a further embodiment, an additional step is provided of storing the image on a network storage device. In a still further embodiment, another step is added to provide access to the images stored on the network data storage device. In yet another embodiment, during the transfer of the image to the mobile device, the image may be converted into a format compatible with the mobile device. Furthermore, the image conversion may also reduce the resolution of the image. The bridge between the mobile device and the camera may have a USB connector at one or both ends.

In another embodiment of the disclosed technology, a method for wirelessly logging an image taken by a standalone digital camera via a mobile device is provided. The method begins with the step of receiving at a network node images transferred from the digital camera via the mobile device, the image having been taken by the digital camera and transferred to the mobile device using a cable. The cable bridges a data output port on the digital camera with a data port on the mobile device. The method proceeds with the step of storing the received image on a network data storage device. The next step involves providing user access to the image on the network data storage device. In a further embodiment, the steps of receiving and storing the image may be performed automatically when the image is taken by the digital camera.

In further embodiments of the disclosed technology, the user may be authenticated before given access to the image on the network data storage device. In yet another embodiment, the step of receiving the image from the mobile device is performed over a cellular network. In still another embodiment, a software application is provided for installation onto said mobile device. The software application may facilitate the step of receiving images. In yet another embodiment, during the transfer of the image to the mobile device, the image may be converted into a format compatible with the mobile device. Furthermore, the image conversion may also reduce the resolution of the image. The bridge between the mobile device and the camera may have a USB connector at one or both ends.

In accordance with these and other objects, which will become apparent hereinafter, the disclosed technology will now be described with particular reference to the drawings.

### BRIEF DESCRIPTION OF THE FIGURES

FIG. 1 is a high level drawing of a standalone digital camera connected to a mobile device, according to an embodiment of the disclosed technology.

FIG. 2 is a high level drawing of the interaction between the digital camera, mobile device, and wireless network.

FIG. 3 is a high level drawing of an exemplary system arrangement for carrying out embodiments of the disclosed technology.

FIG. 4 is a flow chart of an exemplary overview of a method of carrying out embodiments of the disclosed technology.

FIG. 5 is a high level block diagram of a network storage device that may be used to carry out the disclosed technology.

### DETAILED DESCRIPTION OF EMBODIMENTS OF THE DISCLOSED TECHNOLOGY

The technology is directed towards a method of wirelessly logging an image taken by a standalone digital camera via a mobile device. The method involves connecting a digital camera to a mobile device with network connectivity, using a bridged connection or cable. The cable connects a data output port on the digital camera with a data input port on the mobile device. The mobile device is configured to receive a still image taken by the digital camera. Once the picture is taken and stored as an image on the digital camera, it is transferred to the mobile device. Upon receipt of the image by the mobile device, the image is forwarded to a network node via the mobile device's wireless network connection. The image may be stored on a network access drive and accessed remotely by a user. The image may also be converted in format or reduced in resolution upon transfer to the mobile device. The logging of the image may be done automatically immediately after the photo is taken, or automatically as a function of (direct result of) a connection of the digital camera to the mobile device.

Embodiments of the disclosed technology will become clearer in view of the following discussion of the figures.

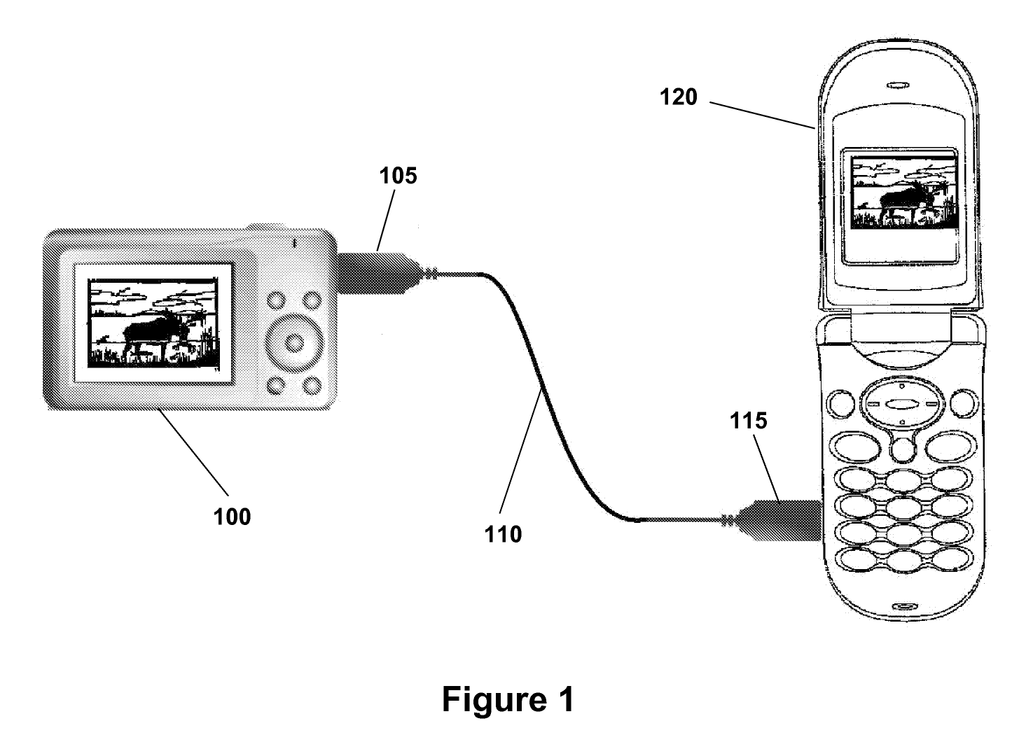

FIG. 1 shows a diagrammatic view of a standalone digital camera connected to a mobile device, according to an embodiment of the disclosed technology. A standalone digital camera 100 is shown bridged with a mobile device 120, using a bridged connection or cable 110. A “standalone digital camera” 100 (hereinafter “camera”), for the purposes of this specification, is any digital single-lens reflex camera (“DSLR”), digital compact camera, bridge digital camera, or any other digital camera which is designed and sold to provide camera functionality only. Such a camera of embodiments of the disclosed technology should be understood to specifically exclude network connectivity and telephonic functions. It is simply and only a camera. A “mobile device” 120, for the purposes of this specification, is a compact electronic computing device with wireless network connectivity via a cellular network provided by a mobile network operator or a voice over IP (internet protocol) connection provided via a wireless data connection. This may include cellular phones, smart phones, personal digital assistants (“PDAs”), and tablet PCs. It should be noted that the mobile device 120 employed by the disclosed method may or may not be equipped with a built-in camera. The existence of a camera built into a mobile device has no bearing on the method of the disclosed technology, as such a camera is separate and distinct from the standalone digital camera employed by the disclosed technology. Such cameras, generally, are not capable of taking images of a resolution and quality comparable to those taken by standalone digital cameras, and are not the object of the method of logging achieved by the disclosed technology. The method of the disclosed technology is limited to the tethering of a standalone camera to a device with network connectivity.

The bridge connection 110 used may be any cable that has connectors 105 and 115 compatible with the data ports of a camera and a mobile phone, respectively. The connectors 105, and 115 employed may be of varying designs, in order enable use of the disclosed technology over a broad spectrum of camera and mobile device models. A Universal Serial Bus (“USB”) connector is an example of a type of connector that may be employed by the disclosed technology. Mini-USB or Micro-USB data ports are found on many of the currently available phone and camera models. Thus, a cable 110 which has a Mini-USB connector at one end and a Micro-USB connector at another is one example of a possible bridge connection configuration. Referring still to FIG. 1, note that the picture shown on the viewfinder of the camera 100 is the same image that is shown on the screen of the mobile device 120. In an embodiment of the disclosed technology, once connected, any photo taken by the camera 100 is transferred as an image to the mobile device 120 via the cable 110.

Numerous other types of cables and connectors may also be employed by the disclosed technology. The output connector from the digital camera may also be a TRRS connector (“Tip, Ring, Ring, Sleeve”) or an HDMI (High-Definition Multimedia Interface) connector. The input connector into the mobile device may also be a TRRS connector or an HDMI connector. Any combination of connectors may be used.

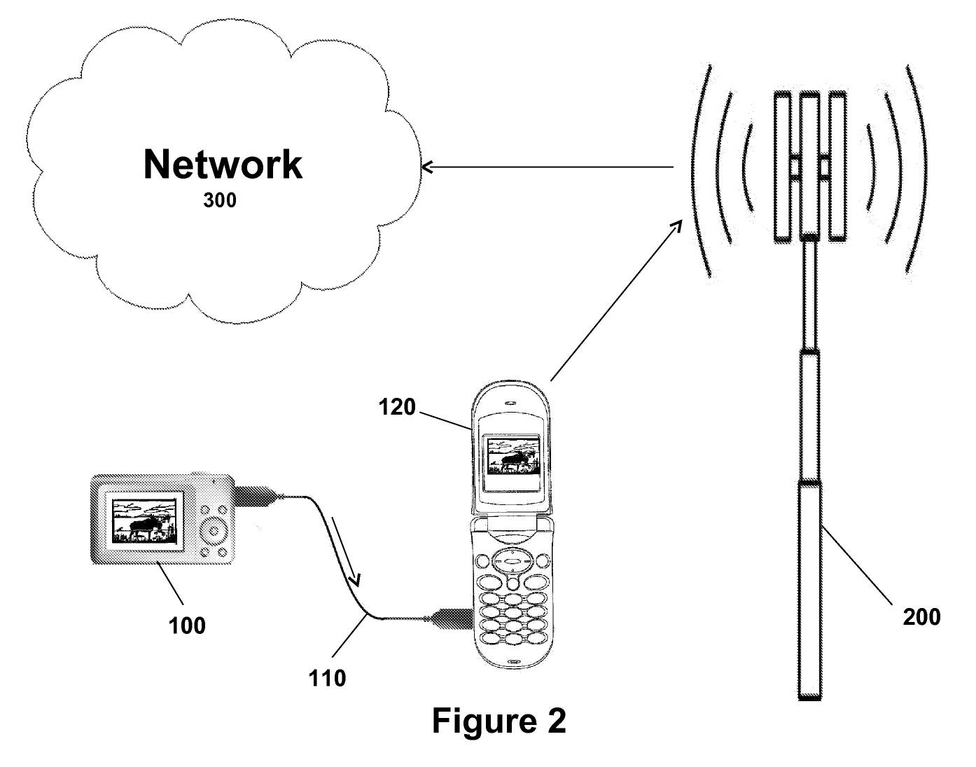

In order to achieve connectivity between two unlike ports with different types of data, the cable may convert data outputted by the camera 100 into a format readable by the camera 120. This may require separate storage, such as RAM (random access memory) or non-volatile memory within the cable itself, as well as code executed to receive the data in a first format (such as raw image data via a USB (universal serial bus) connection), where the data is temporarily stored, converted, and present via a data uplink to a phone 120 with network connectivity. In such a process, the image may be resized and reduced in quality for purposes of uploading to the remote server, as will be described with reference to FIG. 2, below.

In another embodiment of the disclosed technology, a cable 110 connects to the camera by way of providing the camera's storage. That is, storage cards, such as solid state storage devices, are typically used with digital cameras. The cable 110 has an end 105 which interfaces with the electrical connections of the camera used to pass images to the storage card for later retrieval. However, in embodiments of the disclosed technology, the cable 105 intercepts the electrical data used to store the images, and transfers the images via the cable 110 to the mobile device 120 for uploading. The cable 105 may comprise its own flash memory or port to insert a flash memory card in order to store the pictures, as is conventionally done in the art. In this manner, the interface becomes universal as digital cameras sold at the time of this writing generally all have a slot for insertion of a memory card. The cable 110 with connector 105 acts between the camera and a memory card, but also uploads these data while, or just after, being written on the memory card.

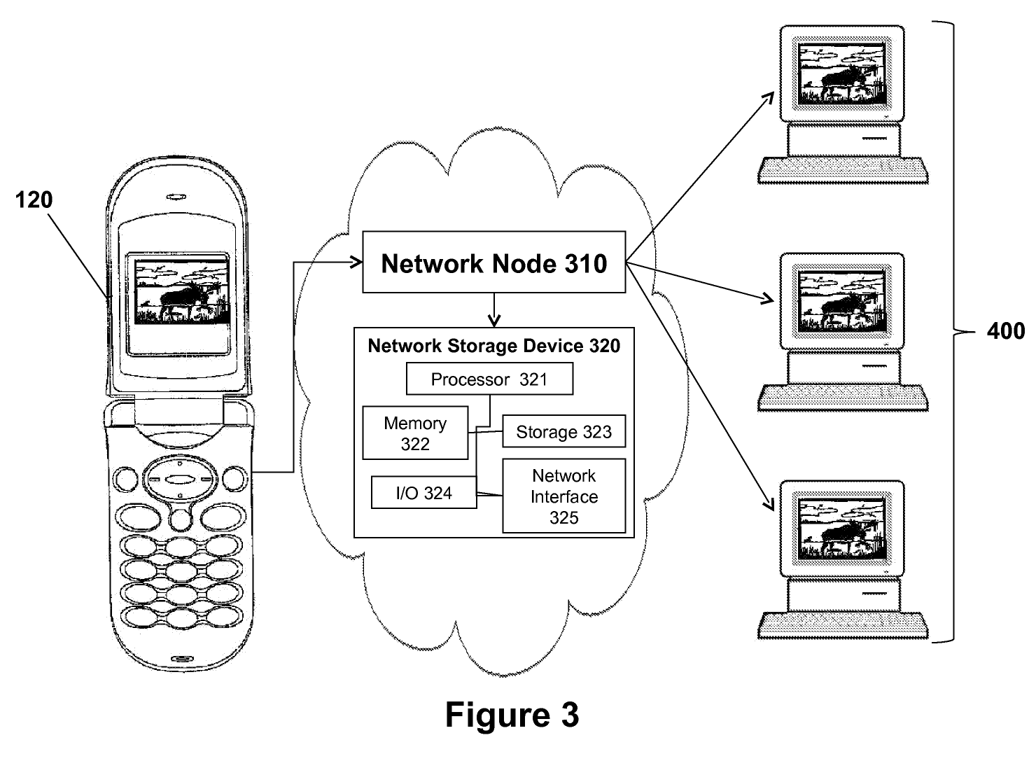

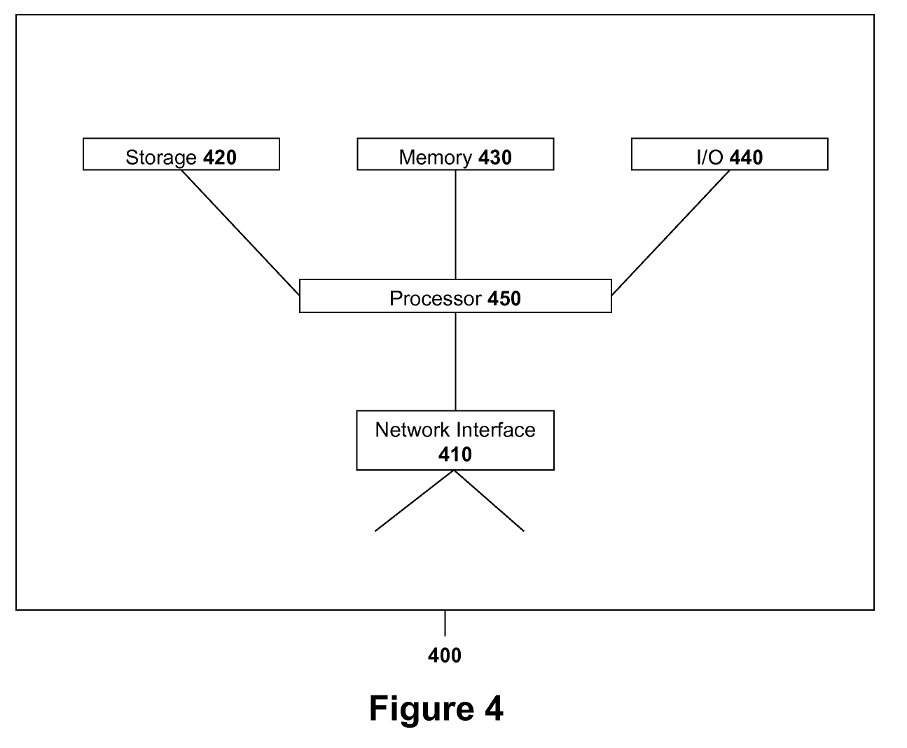

FIG. 2 is a high level drawing of the interaction among the digital camera, mobile device, and wireless network. This figure illustrates the transfer of the image from a camera 100, to a mobile device 120, to a network node 200, and to the network cloud 300. As explained with reference to FIG. 1, the camera 100 is connected to the mobile device 120, and an image taken by the camera is transferred to the mobile device via the provided cable 110 during the process of taking a picture. An interface application may be installed onto the internal memory of the mobile device. The application, specifically programmed for use with the provided cable, facilitates the transfer and logging of images. For example, for an Android phone, a compatible application would be available on the application market. The application works in the same fashion as a personal computer when a camera is plugged into a USB port thereof. The mobile device recognizes the contents of the camera (usually stored on the camera's memory card) and lets a user choose the photos to be transferred. The images are transferred directly from the camera's memory card, thereby inhibiting the use of the camera to write images to the memory card while images are being transferred. The mobile device 120 is preconfigured to operate over a wireless network. A wireless network may be any cellular or wireless wide area network through which data may be sent and received. The data in the form of an image is forwarded to a network 300 by way of a nearby network node 200, such as via a transmitter. The network node 200 and network connectivity service are usually configured and operated by a third-party company such as a cellular phone service provider. Alternatively, an 802.11 network node may be used. These systems will be discussed in greater detail with respect to FIGS. 3 and 4

FIG. 3 is a high level drawing of a system for carrying out embodiments of the disclosed technology. FIG. 3 gives a general overview of how a system may be arranged and the method of logging an image to a network node for access by any device with Internet connectivity. Upon receiving an image, the mobile device 120 transmits the image to a network node 310. The network node 310 is a central repository for all of the images logged by users in an embodiment of the disclosed technology. The network node 310 may alternatively act as an intermediary between a mobile device 120 and a third party online photo hosting website, or any other node. The network node 310 receives the image from the mobile device 120. From there, the images are stored on a network storage device 320. In an embodiment thereof, network storage device 320 comprises a processor 321, memory 322, input/output 323, storage 324, and a network interface 325. These features correspond to those described in further detail below with regard to FIG. 4 and the description thereof, below. In the embodiment shown in FIG. 3, when an image is logged to the network node 310, a user may be identified using the network storage device 320. The image may also be stored on the network storage device 320 in a webpage form unique to that particular user. Such a webpage with the logged image may be accessible by any Internet-capable device on a public network 400. Alternatively, the image may be restricted to being viewed by a user account associated with the user who logged it. In this embodiment, the user would undergo authentication, using certain credentials, before being granted access to the network storage drive 320. In another embodiment, the images and webpages are stored and hosted on a third party server provided by an online photo host.

FIG. 4 is a high level block diagram of a network storage device that may be used to carry out the disclosed technology. A network node 400 comprises a processor 450 that controls the overall operation of the computer by executing the mobile phones image logging which define such operation. The network node's program instructions may be stored in a storage device 420 (e.g., magnetic disk, database) and loaded into memory 430 when execution of the console's program instructions is desired. Thus, the network node's operation will be defined by its program instructions stored in memory 430 and/or storage 420, and the console will be controlled by processor 450 executing the console's program instructions. A network node 400 also includes one, or a plurality of, input network interfaces for communicating with other devices via a network (e.g., the Internet). The network node 400 further includes an electrical input interface for receiving power and data from a power or mobile source. A network node 400 also includes one or more output network interfaces 410 for communicating with other devices. The network node 400 also includes input/output 440 representing devices which allow for user interaction with a computer (e.g., display, keyboard, mouse, speakers, buttons, etc.). One skilled in the art will recognize that an implementation of an actual device will contain other components as well, and that FIG. 4 is a high level representation of some of the components of such a device for illustrative purposes. It should also be understood by one skilled in the art that the method and devices depicted in FIGS. 1 through 3 may be implemented on a device such as is shown in FIG. 4.

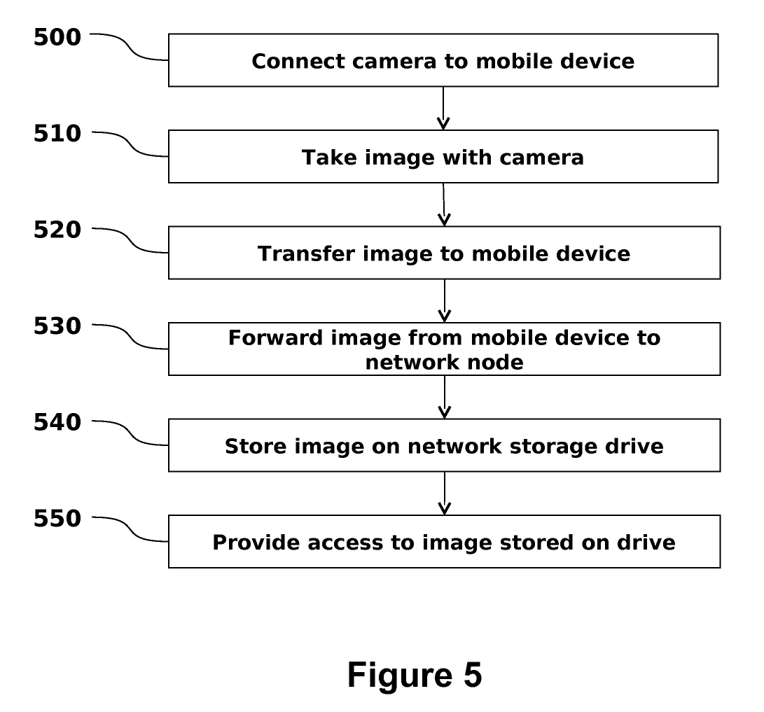

FIG. 5 is a flow chart of an exemplary overview of a method of carrying out embodiments of the disclosed technology. The method begins with step 500, when the camera is connected to the mobile device. This is carried out using the cable as discussed with respect to FIGS. 1 and 2. The method proceeds with step 510, wherein a picture is captured by the camera. As is the case with all digital cameras, a picture taken will be stored onto the camera's internal memory or a compatible memory card in the form of an image file. In step 520, the image file is transferred to the mobile device by way of the connected cable. During this step, the image file is read via a video or image output of the camera, or directly from the camera's memory card, and transferred to the internal memory of the mobile device. The image file may maintain its original properties, such as when received as a JPEG or bitmap. In order to expedite logging via a mobile network, or make such a system more usable, an interface provided on the mobile device may reduce the resolution of the image, thereby reducing the file size. This step may be performed automatically, as soon as the picture is taken. In an alternative embodiment, a user may elect to transfer the image using an interface application stored on the mobile device. Step 530 involves the image being forwarded from the mobile device to a network node via a wireless network accessible by the mobile device. Upon receiving the image at the network node, step 540 involves the image being stored on a network storage drive. The functionality and program instructions of the network storage drive are explained in greater detail with respect to FIGS. 3 and 4. Finally, in step 550, access is provided to the image stored on the network storage drive. Viewing the image may be as simple as accessing a webpage. Access may also require authentication, and may be restricted to the user who logged the image.

In a related method of logging pictures upon generating them, a user takes a picture with a standalone digital camera. The camera is connected to a cable (such as cable 110), such that data sent by the camera intended for storage on a non-volatile storage medium housed with a body of a camera is intercepted. The interception may be via an output of the camera designed to interface with another device, via an electrical connection in the camera designed for interfacing with the storage medium (such as a flash memory card), or the intercepting may simply be interception of a code or electrical signal indicating that the camera is writing to the memory card, whereby the new data (such as a file comprising the image just taken by the camera) is read from the storage medium. The camera and a cable are arranged and configured such that data sent by the camera intended for a non-volatile storage medium (which may or may not actually be stored on the non-volatile storage medium, depending on the embodiments, as described above) housed within a body of a camera is then sent through a cable attached to the camera, and also attached to (by wire or wireless connection) a handheld wireless device. In order to do this, the data is converted into a data format which is receivable by an input on the device with network connectivity. After the conversion, the image data is sent via the cable to the device with network connectivity, and the device configured to upload the data, upon receipt, to a network node.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A method for wirelessly logging an image taken by a standalone digital camera via a mobile device comprising the following steps:
connecting said standalone digital camera to a mobile device comprising wireless network connectivity via a bridged connection between a video output port on said digital camera and a data input port of said mobile device, wherein said standalone digital camera is configured to transfer a still image taken via said video output at a time of taking a picture;
upon taking a picture with said camera, storing said picture as an image stored on a storage medium of said digital camera and, at the same time, transferring said image to said mobile device; and
upon receipt of said image by said mobile device, forwarding said image to a network node via said wireless network.

2. The method of claim 1, further comprising a step of storing said image on a network storage device.

3. The method of claim 2, further comprising a step of providing access to said images stored on said network data storage device.

4. The method of claim 3, wherein said image is converted to a format compatible with said mobile device during said transferring of said image.

5. The method of claim 4, wherein said image conversion reduces the resolution of said image.

6. The method of claim 1, wherein said cable comprises a universal serial bus connector.

7. A method for wirelessly logging an image taken by a standalone digital camera via a mobile device comprising the following steps:
receiving at a network node an image transferred from said digital camera via said mobile device, said image having been taken by said digital camera and transferred to said mobile device using a cable, said cable bridging a data output port on said digital camera with a data port on said mobile device;
storing said received image on a network data storage device; and
providing access to said image stored on said network data storage device to a user.

8. The method of claim 7, wherein said step of receiving said image and storing said image is performed automatically when said image is taken by said digital camera.

9. The method of claim 7, wherein said user is authenticated before given access to said image on said network data storage device.

10. The method of claim 7, wherein said step of receiving an image is performed over a cellular network.

11. The method of claim 7, wherein a software application is provided for installation onto said mobile device, and said software application facilitates said step of receiving images.

12. The method of claim 7, wherein said image is converted to a format compatible with said mobile device during said transfer of said image.

13. The method of claim 12, wherein said image conversion reduces the resolution of said image.

14. The method of claim 7, wherein said cable comprises a USB connector.

15. A method of logging pictures upon generating same, comprising:
taking a picture with a standalone digital camera;
arranging said camera and a cable such that data sent by the camera intended for a non-volatile storage medium housed within a body of said camera is intercepted;
converting said intercepted data into a data format that is receivable by a device with network connectivity;
after said converting, sending said data in the form of image data via said cable to said device with network connectivity; wherein
said device with network connectivity is configured to upload said data, upon receipt, to a network node.
